(19) United States
(12) Patent Application Publication
(10) Pub. No.: US 2026/0156693 A1
(43) Pub. Date: Jun. 4, 2026

(54) SYSTEMS AND METHODS FOR APPLICATION-INITIATED NETWORK SLICE MODIFICATION

(71) Applicant: Verizon Patent and Licensing Inc., Basking Ridge, NJ (US)

(72) Inventors: Ambreen Habib, Golden, CO (US); Samirkumar Patel, Middlesex, NJ (US); Raquel Morera Sempere, Weehawken, NJ (US)

(73) Assignee: Verizon Patent and Licensing Inc., Basking Ridge, NJ (US)

(21) Appl. No.: 18/964,381

(22) Filed: Nov. 30, 2024

(51) Int. Cl. H04W 76/10; H04W 48/18; H04W 64/00

(52) U.S. Cl. CPC H04W 76/10; H04W 48/18; H04W 64/00

(57) ABSTRACT

A device may receive, from an application executing at the device, a first request; establish a first communication session with a wireless network, the first communication session being associated with a first network slice out of a plurality of network slices. The device may receive, from the wireless network, updated network slice information; may provide, to the application, at least a portion of the updated network slice information; and may receive, from the application and after providing the updated network slice information to the application, a second request. The device may establish, based on the second request, a second communication session that is associated with a second network slice, and/or may modify the first communication session with the wireless network to be associated with the second network slice.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. Wireless networks may include various network slices, via which the wireless networks may provide differing levels of Quality of Service (“QoS”) to UEs. The differing levels of QoS may be provided based on, for example, particular categories or classes of UEs (e.g., “first responder” UEs, “enterprise” UEs, etc.), different application or service types (e.g., voice calls, content streaming, etc.), and/or on some other basis.

### BRIEF DESCRIPTION OF THE DRAWINGS

FIG. 1 illustrates an example overview of one or more embodiments described herein;

FIG. 2 illustrates example communications between components of a UE, in accordance with some embodiments;

FIG. 3 illustrates an example process for establishing and maintaining a communication session between a UE and a wireless network based on network slice information that is updated on an ongoing basis, in accordance with some embodiments;

FIGS. 4 and 5 illustrate example environments in which one or more embodiments, described herein, may be implemented;

FIG. 6 illustrates an example arrangement of a radio access network (“RAN”), in accordance with some embodiments; and

FIG. 7 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

UEs may access different network slices of a wireless network based on factors such as UE device type (e.g., mobile phone, IoT device, M2M device, etc.), UE group or category (e.g., “first responder,” “enterprise,” etc.), location (e.g., certain network slices may be implemented or available in a given location and unavailable in other locations), and/or other factors. As such, a UE may be authorized to access a certain set of network slices implemented by a wireless network, without necessarily being authorized to access other network slices implemented by the wireless network.

Situations may arise in which the authorized network slices for a given UE change. For example, a UE may move from one location (e.g., a tracking area (“TA”), a cell, a sector, a geographical region, etc.) to another, where a particular network slice is available at the new location but was not available at the initial location. As another example, a wireless network may adjust permissions for a given network slice (e.g., may allow fewer or additional UEs to access the network slice) in certain situations, such as allowing fewer UEs on a network slice that is relatively heavily loaded and/or allowing more UEs on a network slice that is relatively less heavily loaded. As yet another example, a category or priority level of a UE may be changed, and access to a given network slice may be granted or revoked based on the change in the category or priority level of the UE.

A UE may receive an indication of network slices that the UE is authorized to access (e.g., an allowed Network Slice Selection Assistance Information (“NSSAI”) list) from a wireless network (e.g., from an access control function of the wireless network such as an Access and Mobility Management Function (“AMF”) or a Mobility Management Entity (“MME”)). The information may be provided as part of a registration procedure between the UE and the wireless network, as part of an over-the-air (“OTA”) update procedure, and/or some other suitable procedure. In some embodiments, the information may include one or more UE Route Selection Policy (“URSP”) rules, which indicate particular traffic descriptors or attributes (e.g., application or service type, traffic header information, labels, and/or other suitable traffic descriptors) that may be used by the UE (e.g., by network connectivity circuitry of the UE such as a modem) to route any given traffic to an appropriate network slice. For example, the URSP rules may indicate that traffic associated with a first set of traffic descriptors should be routed to the wireless network via a first network slice, and that traffic associated with a second set of traffic descriptors should be routed to the wireless network via a second network slice.

Applications executing on a UE may receive (e.g., from an operating system or kernel of the UE, an application programming interface (“API”), etc.) an indication of network slices for which the UE is authorized (and/or for which particular applications are authorized), an indication of traffic descriptors that are applicable to network slices for which the UE is authorized, an indication of QoS parameters (e.g., latency thresholds, throughput thresholds, etc.) associated with network slices for which the UE is authorized, and/or other suitable network slice information. For example, when initiating network connectivity in order to send and receive communications via the wireless network, an application may request network slice information (e.g., from the operating system or kernel of the UE), such as a list of allowed network slices, a list of traffic descriptors associated with respective different network slices or QoS parameters, or the like.

The application may select a particular network slice (e.g., from the list of allowed network slices), and/or may otherwise select a particular set of QoS parameters that should be applied to network traffic associated with the application. For example, the application may be configured with information specifying QoS thresholds, traffic types, etc. associated with the application. In this sense, the application may be “aware” of QoS parameters that should be applied to network traffic associated with the application. When initiating a communication session (e.g., a protocol data unit (“PDU”) session or some other suitable type of communication session) with the wireless network, the application may indicate or request the selected network slice or other QoS parameters for the communication session. In some embodiments, the request may include a network slice identifier (e.g., an NSSAI value or other suitable identifier). In some embodiments, the request may include additional or different information based on which the selected network slice may be ascertained, such as one or more labels, flags, traffic descriptors, or the like.

As noted above, certain situations may arise in which the available network slices for a given UE or application may change, such as a change in location of the UE, network-initiated policy changes, changes to URSP rules, UE information changes (e.g., subscription information changes), or the like. In situations where an application has established a communication session via a particular slice that is no longer available (e.g., due to such changes), the application may experience a period of disruption due to, for example, the wireless network rejecting traffic via the particular slice while the application is “unaware” that the slice is no longer available for use by the application. Similarly, in situations where a more “favorable” network slice is available (e.g., a network slice with a higher measure of QoS such as lower latency or increased throughput), the application may be “unaware” that such slice is available and may continue using a network slice for a previously established communication session.

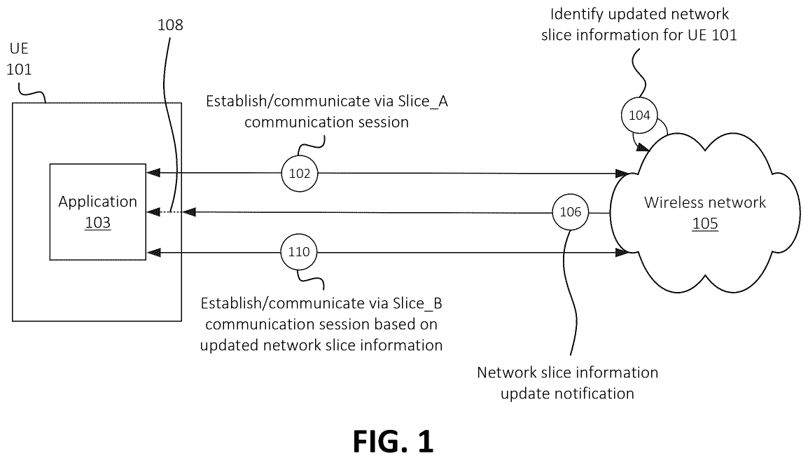

Embodiments described herein provide for a mechanism by which applications executing on UEs may be notified of updates to network slice availability information, and may dynamically select or re-select a network slice for communications with a wireless network using such information. As shown in the example of FIG. 1, for example, a particular UE 101 may execute one or more applications (or “apps”), such as web browser applications, content streaming applications, gaming applications, and so on. In this example, the applications executed by UE 101 may include a particular application 103. The applications executed by UE 101 may include network applications that communicate with one or more other devices or systems (e.g., application servers, content streaming servers, other UEs, etc.) via one or more networks, such as wireless network 105, in order to receive services provided by or to otherwise communicate with the other devices or systems.

As shown, for example, application 103 may establish (at 102) a communication session, which may include an Internet Protocol (“IP”)-based communication session such as a PDU session, with wireless network 105. In the course of establishing the communication session, application 103 may request a particular network slice and/or may output other information (e.g., labels, flags, traffic descriptors, etc.) based on which the particular network slice may be indicated. For example, as noted above, UE 101 may be configured with and/or may receive network slice routing information, such as URSP rules, and may provide (e.g., via an application programming interface (“API”), a software development kit (“SDK”), functionality of an operating system (“OS”) of UE 101, and/or via some other suitable communication pathway) some or all of such network slice routing information to application 103 and/or to other applications. As noted above, the URSP rules may include network slice identifiers, QoS parameters, labels, flags, traffic descriptors, etc. that are applicable to respective applications or traffic that meet certain criteria, such as application or traffic type or other criteria.

Application 103 may identify (e.g., based on the URSP rules) a particular network slice, a particular set of QoS parameters, a particular label, etc. to include in a request to establish the communication session. In some embodiments, one or more elements of UE 101 (e.g., a network interface such as a modem) may perform further processing to determine a particular network slice to request for the communication session. For example, the network interface may receive, from application 103, a request for a particular set of QoS parameters, and may identify a particular network slice (e.g., “Slice_A”), in this example, that is suitable for the particular set of QoS parameters. As another example, application 103 may request a first network slice and the network interface may select a different second network slice (e.g., based on factors that are not necessarily available to application 103, such as private network analytics of wireless network 105). In other example situations, UE 101 may perform other mapping, processing, etc. to identify the particular network slice to request for a communication session between application 103 and wireless network 105.

Once established, application 103 and one or more other devices or systems may communicate (at 102) via wireless network 105. For example, communications between application 103 and wireless network 105 may be provided via the particular network slice, which may include wireless network 105 implementing containerization techniques, priority-based routing techniques, or other suitable techniques in order to implement QoS parameters or Service Level Agreements (“SLAs”) associated with the particular network slice.

At some point in time, wireless network 105 may receive or identify (at 104) updated network slice information for UE 101. In this example, assume that the updated network slice information is applicable to application 103. For example, the updated network slice information may indicate that Slice_A is no longer available, which may include situations such as UE 101 no longer being authorized for Slice_A, application 103 no longer being authorized for Slice_A, a congestion or unavailability condition associated with Slice_A, and/or other situations. Additionally, or alternatively, the updated network slice information may indicate the availability of another network slice, such as Slice_B. Slice_B may have been unavailable at the time that the communication session associated with Slice_A was established (at 102). In one example, Slice_A may be a “default” slice used when other network slices, such as Slice_B, are not available.

For example, application 103 may not have received information indicating that Slice_B was available when receiving URSP rules or other suitable information from one or more other elements of UE 101. Additionally, or alternatively, the updated network slice information may include updated URSP rules, based on which Slice_B would be selected in lieu of Slice_A if application 103 were to initiate a communication session. As another example, wireless network 105 may determine that a location of UE 101 has changed from a location in which Slice_A is available and/or Slice_B is unavailable, to a location in which Slice_A is unavailable and/or Slice_B is available. In some embodiments, wireless network 105 may receive or determine some other change to network slice information (e.g., URSP rules, UE slice authorization information, etc.) in addition to the examples described above.

Wireless network 105 may provide (at 106) a notification to UE 101, indicating the updated network slice information (e.g., an indication of availability of Slice_B, an indication of unavailability of Slice_A, a change in priority or URSP rules associated with Slice_A, a change in priority or URSP rules associated with Slice_B, a change in URSP rules associated with application 103, etc.). Wireless network 105 may provide such information as part of a registration procedure, a mobility procedure (e.g., a handover of UE 101 from one portion of a radio access network (“RAN”) of wireless network 105 to another), an OTA update procedure, or some other suitable procedure. The network slice information update notification may be received by a network interface of UE 101, such as a modem.

In accordance with some embodiments, UE 101 may further provide (at 108) an indication, of the updated network slice information, to application 103. For example, as discussed below, UE 101 may implement an API, an SDK, and/or some other suitable mechanism by which updated network slice information may be provided (at 108) to application 103 in real time (or near-real time) as updated network slice information is received (e.g., at 106) by UE 101. In this manner, application 103 may be informed, in real time or near-real time, of such changes and may be able to initiate (at 110) the establishment or modification of a communication session, between application 103 and wireless network 105, using the updated network slice information.

Establishing or modifying (at 110) the communication session via Slice_B may include, in some embodiments, outputting a PDU session modification request. The session modification request may include an identifier of Slice_B and/or other suitable traffic descriptors based on which Slice_B may be identified. Additionally, or alternatively, application 103 may request the establishment of a new communication session (e.g., a PDU session establishment request), and may specify Slice_B in such request. In such implementations, application 103 may request that the previous communication session, associated with Slice_A, be removed or de-provisioned. On the other hand, in some scenarios, application 103 may not request that the previous communication session be removed or de-provisioned.

Application 103 may identify, based on the updated network slice information (received at 106 and 108), that Slice_B should be used instead of Slice_A. For example, the updated network slice information may include priority information indicating that Slice_B is associated with a higher measure of priority than Slice_A (e.g., where Slice_A was previously a higher priority slice than Slice_B). As another example, the updated network slice information may include an indication that Slice_A is no longer available, and/or that Slice_B is available. Additionally, or alternatively, the updated network slice information may include different labels, traffic descriptors, etc. for application 103 to apply to network traffic. The different labels, traffic descriptors, etc. may be associated with Slice_B and may be different from labels, traffic descriptors, etc. that are associated with Slice_A and which were previously used (at 102) for communicating with wireless network 105.

As noted above, in one example, Slice_A may be unavailable in a location to which UE 101 has moved, or may be undergoing a congestion or failure condition. In another example, UE 101 and/or application 103 may have been de-authorized (e.g., by wireless network 105) to access Slice_A. In either example, if application 103 were not made aware of these conditions, application 103 could potentially continue to attempt to communicate with wireless network 105 using Slice_A. Such attempts may be rejected by wireless network 105 and/or communications may be undeliverable via Slice_A, thus disrupting the functionality of application 103.

In another example, Slice_B may provide higher measures of performance or QoS (e.g., lower latency, higher throughput, higher reliability, etc.) than Slice_A, and using Slice_B instead of Slice_A may improve the functionality or performance of application 103. In some instances, application 103 may modify application layer parameters of network traffic when using Slice_B (e.g., as compared to Slice_A), such as a bitrate, a codec, or the like. In some embodiments, application 103 may output an indication to one or more other devices or systems, such as an application server with which application 103 communicates (e.g., in order to receive a service provided by such application server), of the updated network slice information. In this manner, the application server may become “aware” of the change in network slice and/or in QoS parameters associated with such network slice, and may implement application layer traffic parameters or other parameters accordingly.

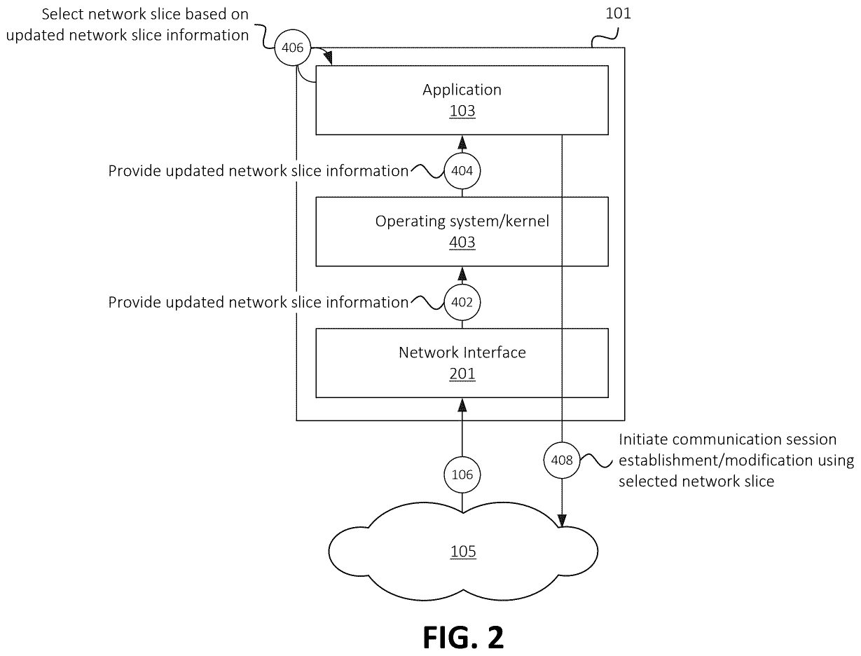

FIG. 2 illustrates an example of various components of UE 101 communicating with each other in order to implement some of the operations described above. As shown in FIG. 2, for example, network interface 201 of UE 101 may receive (at 106) a network slice information update notification. As discussed above, the network slice information update notification may include network slice information such as updated URSP rules, updated network slice authorization or availability information, etc. Network interface 201 may provide (at 402) some or all of the network slice information to OS/kernel 403 of UE 101. In accordance with some embodiments, application 103 may provide (at 404) some or all of the updated network slice information to application 103. For example, application 103 and/or application 103 may implement an API, an SDK, and/or some other suitable interface via which application 103 is able to notify application 103 of the updated network slice information.

In some embodiments, application 103 may provide (at 404) only network slice information that is applicable to application 103. For example, application 103 may identify a network slice that is currently in use by application 103, and may provide (at 404) updated information pertaining to such network slice, such as information indicating that UE 101 is no longer authorized to access the network slice. As another example, application 103 may identify that a particular URSP rule included in the updated network slice information includes one or more traffic attributes that are currently being applied by application 103, and may provide the updated URSP rule to application 103. As yet another example, application 103 may identify that the updated network slice information indicates that an application identifier of application 103 is specified as being authorized or not authorized for a particular network slice, and may provide such information to application 103. In some embodiments, application 103 may perform some other sort of filtering or condition-based processing to provide some, but not all, of the received (at 402) updated network slice information to application 103 (e.g., only updated network slice information that is applicable or relevant to application 103).

As discussed above, application 103 may utilize the updated network slice information to select (at 406) a particular network slice, which may be a different network slice than is being currently used or accessed by application 103. For example, as discussed above, application 103 may select a network slice (such as a network slice newly indicated in the updated network slice information) based on improved measures of performance or QoS associated with such network slice, to account for unavailability or failure of a previously used network slice, and/or based on other factors. Application 103 may proceed to initiate (at 408) a communication session establishment and/or modification procedure using the newly selected (at 406) network slice, as discussed above. In this manner, application 103 may be able to proactively and dynamically select network slices provided by wireless network 105, in a manner that avoids potential disruptions in situations where a currently used network slice becomes unavailable and further maximizes QoS in situations where a newly available network slice provides improved performance over the currently used network slice.

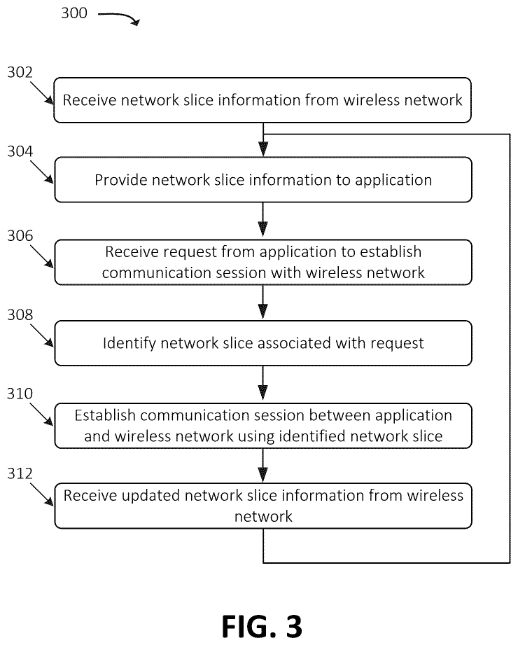

FIG. 3 illustrates an example process 300 for establishing and maintaining a communication session between UE 101 (e.g., an application 103 executing at UE 101) and wireless network 105 based on network slice information that is updated on an ongoing basis. In some embodiments, some or all of process 300 may be performed by UE 101 (e.g., by network interface 201, OS/kernel 403, and/or application 103 executing at UE 101).

As shown, process 300 may include receiving (at 302) network slice information from wireless network 105. For example, as discussed above, UE 101 (e.g., network interface 201 and/or application 103) may receive network slice authorization information, URSP rules, network slice availability information, and/or other suitable information. In some embodiments, such information may be based on information maintained in a UE information repository of wireless network 105, such as a Home Subscriber Server (“HSS”), a Unified Data Management function (“UDM”), or a Unified Data Repository (“UDR”). In some embodiments, UE 101 may receive (at 302) the network slice information as part of an initial provisioning procedure, a registration procedure, an OTA update procedure, and/or some other suitable procedure.

Process 300 may further include providing (at 304) at least a portion of the network slice information to one or more applications executing on UE 101, such as a particular application 103. For example, application 103 may request network slice authorization information, URSP rules, and/or other suitable information prior to requesting connectivity to wireless network 105.

Process 300 may additionally include receiving (at 306) a request from application 103 to establish a communication session with wireless network 105. For example, the request may include a PDU session establishment request, which specifies a particular network slice and/or includes information (e.g., traffic descriptors, labels, or the like) based on which the particular network slice may be identified.

Process 300 may also include identifying (at 308) a network slice associated with the request. For example, in instances where the request includes a network slice identifier (e.g., an NSSAI value or other suitable identifier), UE 101 may identify such network slice as the network slice with which the requested communication session should be associated. In some embodiments, as discussed above, UE 101 may perform further processing or mapping to identify the appropriate network slice based on the information included in the request.

Process 300 may further include establishing (at 310) a communication session, such as a PDU session, between application 103 and wireless network 105 using the identified network slice. For example, UE 101 (e.g., network interface 201) may assign an IP address and/or port number for application 103, and may use such IP address and/or port number for a PDU session or other suitable communication session between UE 101 and wireless network 105. Traffic received, for example, via the PDU session (e.g., specifying the IP address and/or port number for application 103) may be routed by UE 101 (e.g., by network interface 201) to application 103. As noted above, wireless network 105 and/or UE 101 may perform QoS processing, routing, filtering, or other suitable processing on traffic associated with the established PDU session in accordance with the network slice with which the communication session has been associated.

Process 300 may additionally include receiving (at 312) updated network slice information from wireless network 105. For example, as discussed above, wireless network 105 may determine updated network slice information based on factors such as a movement of UE 101 from one location to another, congestion (or lack thereof) of one or more network slices, failure or unavailability of one or more network slices, increased availability of one or more network slices, URSP or other policy changes for one or more network slices, or the like.

Some or all of the operations of process 300 may be repeated based on the updated network slice information. For example, at a subsequent iteration, wireless network 105 may provide or “push” (at 304) the updated network information to UE 101 (e.g., to network interface 201). For example, in accordance with some embodiments, network interface 201 may provide (e.g., “push” via an API, an SDK, application 103, and/or some other suitable communication pathway) at least a portion of the updated network information to application 103. For example, as discussed above, UE 101 may identify network slice information updates that are relevant or applicable to application 103 and/or to traffic sent via a communication session associated with application 103, and may provide such updates to application 103.

As further noted above, application 103 may select a different network slice, or other network slice-related information (e.g., traffic descriptors, labels, flags, etc. to apply to network traffic) based on the updated network slice information. Application 103 may accordingly request (e.g., at a subsequent iteration of operation 306) a communication via the newly selected slice. For example, application 103 may request the establishment of a new communication session (e.g., a new PDU session) using the newly selected slice, and/or a modification of the previously established communication session to use the newly selected slice in lieu of the slice that was previously being used.

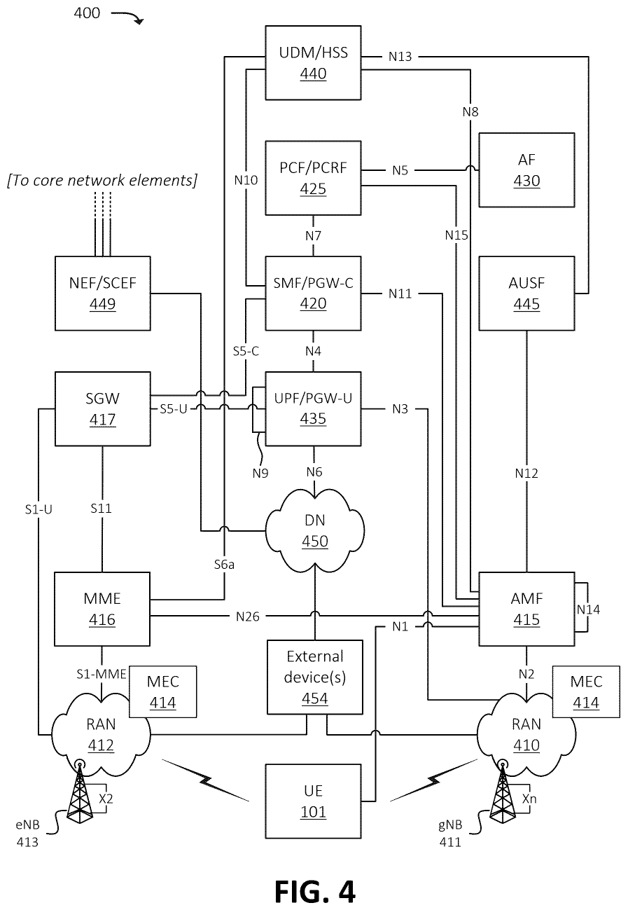

FIG. 4 illustrates an example environment 400, in which one or more embodiments may be implemented. In some embodiments, environment 400 may correspond to a Fifth Generation (“5G”) network, and/or may include elements of a 5G network. In some embodiments, environment 400 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 400 may represent or may include a 5G core (“5GC”). As shown, environment 400 may include UE 101, RAN 410 (which may include one or more Next Generation Node Bs (“gNBs”) 411), RAN 412 (which may include one or more evolved Node Bs (“eNBs”) 413), and various network functions such as AMF 415, MME 416, Serving Gateway (“SGW”) 417, Session Management Function (“SMF”)/Packet Data Network (“PDN”) Gateway (“PGW”)-Control plane function (“PGW-C”) 420, Policy Control Function (“PCF”)/Policy Charging and Rules Function (“PCRF”) 425, Application Function (“AF”) 430, User Plane Function (“UPF”)/PGW-User plane function (“PGW-U”) 435, UDM/HSS 440, Authentication Server Function (“AUSF”) 445, and Network Exposure Function (“NEF”)/Service Capability Exposure Function (“SCEF”) 449. Environment 400 may also include one or more networks, such as Data Network (“DN”) 450. Environment 400 may include one or more additional devices or systems communicatively coupled to one or more networks (e.g., DN 450), such as one or more external devices 454.

The example shown in FIG. 4 illustrates one instance of each network component or function (e.g., one instance of SMF/PGW-C 420, PCF/PCRF 425, UPF/PGW-U 435, UDM/HSS 440, and/or AUSF 445). In practice, environment 400 may include multiple instances of such components or functions. For example, in some embodiments, environment 400 may include multiple “slices” of a core network, where each slice includes a discrete and/or logical set of network functions (e.g., one slice may include a first instance of AMF 415, SMF/PGW-C 420, PCF/PCRF 425, and/or UPF/PGW-U 435, while another slice may include a second instance of AMF 415, SMF/PGW-C 420, PCF/PCRF 425, and/or UPF/PGW-U 435). The different slices may provide differentiated levels of service, such as service in accordance with different Quality of Service (“QoS”) parameters.

The quantity of devices and/or networks, illustrated in FIG. 4, is provided for explanatory purposes only. In practice, environment 400 may include additional devices and/or networks, fewer devices and/or networks, different devices and/or networks, or differently arranged devices and/or networks than illustrated in FIG. 4. For example, while not shown, environment 400 may include devices that facilitate or enable communication between various components shown in environment 400, such as routers, modems, gateways, switches, hubs, etc. In some implementations, one or more devices of environment 400 may be physically integrated in, and/or may be physically attached to, one or more other devices of environment 400. Alternatively, or additionally, one or more of the devices of environment 400 may perform one or more network functions described as being performed by another one or more of the devices of environment 400.

Additionally, one or more elements of environment 400 may be implemented in a virtualized and/or containerized manner. For example, one or more of the elements of environment 400 may be implemented by one or more Virtualized Network Functions (“VNFs”), Cloud-Native Network Functions (“CNFs”), etc. In such embodiments, environment 400 may include, may implement, and/or may be communicatively coupled to an orchestration platform that provisions hardware resources, installs containers or applications, performs load balancing, and/or otherwise manages the deployment of such elements of environment 400. In some embodiments, such orchestration and/or management of such elements of environment 400 may be performed by, or in conjunction with, the open-source Kubernetes® application programming interface (“API”) or some other suitable virtualization, containerization, and/or orchestration system.

Elements of environment 400 may interconnect with each other and/or other devices via wired connections, wireless connections, or a combination of wired and wireless connections. Examples of interfaces or communication pathways between the elements of environment 400, as shown in FIG. 4, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 4, such as Service-Based Interfaces (“SBIs”), including an Namf interface, an Nudm interface, an Npcf interface, an Nupf interface, an Nnef interface, an Nsmf interface, and/or one or more other SBIs. In some embodiments, environment 400 may be, may include, may be implemented by, and/or may be communicatively coupled to wireless network 105.

UE 101 may include a computation and communication device, such as a wireless mobile communication device that is capable of communicating with RAN 410, RAN 412, and/or DN 450. UE 101 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 101 may send traffic to and/or receive traffic (e.g., user plane traffic) from DN 450 via RAN 410, RAN 412, and/or UPF/PGW-U 435.

RAN 410 may be, or may include, a 5G RAN that implements a 5G RAT and that includes one or more base stations (e.g., one or more gNBs 411), via which UE 101 may communicate with one or more other elements of environment 400. UE 101 may communicate with RAN 410 via an air interface (e.g., as provided by gNB 411). For instance, RAN 410 may receive traffic (e.g., user plane traffic such as voice call traffic, data traffic, messaging traffic, etc.) from UE 101 via the air interface, and may communicate the traffic to UPF/PGW-U 435 and/or one or more other devices or networks. Further, RAN 410 may receive signaling traffic, control plane traffic, etc. from UE 101 via the air interface, and may communicate such signaling traffic, control plane traffic, etc. to AMF 415 and/or one or more other devices or networks. Additionally, RAN 410 may receive traffic intended for UE 101 (e.g., from UPF/PGW-U 435, AMF 415, and/or one or more other devices or networks) and may communicate the traffic to UE 101 via the air interface.

RAN 412 may be, or may include, an LTE RAN that implements an LTE RAT and that includes one or more base stations (e.g., one or more eNBs 413), via which UE 101 may communicate with one or more other elements of environment 400. UE 101 may communicate with RAN 412 via an air interface (e.g., as provided by eNB 413). For instance, RAN 412 may receive traffic (e.g., user plane traffic such as voice call traffic, data traffic, messaging traffic, signaling traffic, etc.) from UE 101 via the air interface, and may communicate the traffic to UPF/PGW-U 435 (e.g., via SGW 417) and/or one or more other devices or networks. Further, RAN 412 may receive signaling traffic, control plane traffic, etc. from UE 101 via the air interface, and may communicate such signaling traffic, control plane traffic, etc. to MME 416 and/or one or more other devices or networks. Additionally, RAN 412 may receive traffic intended for UE 101 (e.g., from UPF/PGW-U 435, MME 416, SGW 417, and/or one or more other devices or networks) and may communicate the traffic to UE 101 via the air interface.

One or more RANs of environment 400 (e.g., RAN 410 and/or RAN 412) may include, may implement, and/or may otherwise be communicatively coupled to one or more edge computing devices, such as one or more Multi-Access/Mobile Edge Computing (“MEC”) devices (referred to sometimes herein simply as a “MECs”) 414. MECs 414 may be co-located with wireless network infrastructure equipment of RANs 410 and/or 412 (e.g., one or more gNBs 411 and/or one or more eNBs 413, respectively). Additionally, or alternatively, MECs 414 may otherwise be associated with geographical regions (e.g., coverage areas) of wireless network infrastructure equipment of RANs 410 and/or 412. In some embodiments, one or more MECs 414 may be implemented by the same set of hardware resources, the same set of devices, etc. that implement wireless network infrastructure equipment of RANs 410 and/or 412. In some embodiments, one or more MECs 414 may be implemented by different hardware resources, a different set of devices, etc. from hardware resources or devices that implement wireless network infrastructure equipment of RANs 410 and/or 412. In some embodiments, MECs 414 may be communicatively coupled to wireless network infrastructure equipment of RANs 410 and/or 412 (e.g., via a high-speed and/or low-latency link such as a physical wired interface, a high-speed and/or low-latency wireless interface, or some other suitable communication pathway).

MECs 414 may include hardware resources (e.g., configurable or provisionable hardware resources) that may be configured to provide services and/or otherwise process traffic to and/or from UE 101, via RAN 410 and/or 412. For example, RAN 410 and/or 412 may route some traffic from UE 101 (e.g., traffic associated with one or more particular services, applications, application types, etc.) to a respective MEC 414 instead of to core network elements of 400 (e.g., UPF/PGW-U 435). MEC 414 may accordingly provide services to UE 101 by processing such traffic, performing one or more computations based on the received traffic, and providing traffic to UE 101 via RAN 410 and/or 412. MEC 414 may include, and/or may implement, some or all of the functionality described above with respect to UPF/PGW-U 435, AF 430, one or more application servers, and/or one or more other devices, systems, VNFs, CNFs, etc. In this manner, ultra-low latency services may be provided to UE 101, as traffic does not need to traverse links (e.g., backhaul links) between RAN 410 and/or 412 and the core network.

AMF 415 may include one or more devices, systems, VNFs, CNFs, etc., that perform operations to register UE 101 with the 5G network, to establish bearer channels associated with a session with UE 101, to hand off UE 101 from the 5G network to another network, to hand off UE 101 from the other network to the 5G network, manage mobility of UE 101 between RANs 410 and/or gNBs 411, and/or to perform other operations. In some embodiments, the 5G network may include multiple AMFs 415, which communicate with each other via the N14 interface (denoted in FIG. 4 by the line marked “N14” originating and terminating at AMF 415).

MME 416 may include one or more devices, systems, VNFs, CNFs, etc., that perform operations to register UE 101 with the EPC, to establish bearer channels associated with a session with UE 101, to hand off UE 101 from the EPC to another network, to hand off UE 101 from another network to the EPC, manage mobility of UE 101 between RANs 412 and/or eNBs 413, and/or to perform other operations.

SGW 417 may include one or more devices, systems, VNFs, CNFs, etc., that aggregate traffic received from one or more eNBs 413 and send the aggregated traffic to an external network or device via UPF/PGW-U 435. Additionally, SGW 417 may aggregate traffic received from one or more UPF/PGW-Us 435 and may send the aggregated traffic to one or more eNBs 413. SGW 417 may operate as an anchor for the user plane during inter-eNB handovers and as an anchor for mobility between different telecommunication networks or RANs (e.g., RANs 410 and 412).

SMF/PGW-C 420 may include one or more devices, systems, VNFs, CNFs, etc., that gather, process, store, and/or provide information in a manner described herein. SMF/PGW-C 420 may, for example, facilitate the establishment of communication sessions on behalf of UE 101. In some embodiments, the establishment of communications sessions may be performed in accordance with one or more policies provided by PCF/PCRF 425.

PCF/PCRF 425 may include one or more devices, systems, VNFs, CNFs, etc., that aggregate information to and from the 5G network and/or other sources. PCF/PCRF 425 may receive information regarding policies and/or subscriptions from one or more sources, such as subscriber databases and/or from one or more users (such as, for example, an administrator associated with PCF/PCRF 425).

AF 430 may include one or more devices, systems, VNFs, CNFs, etc., that receive, store, and/or provide information that may be used in determining parameters (e.g., quality of service parameters, charging parameters, or the like) for certain applications.

UPF/PGW-U 435 may include one or more devices, systems, VNFs, CNFs, etc., that receive, store, and/or provide data (e.g., user plane data). For example, UPF/PGW-U 435 may receive user plane data (e.g., voice call traffic, data traffic, etc.), destined for UE 101, from DN 450, and may forward the user plane data toward UE 101 (e.g., via RAN 410, SMF/PGW-C 420, and/or one or more other devices). In some embodiments, multiple instances of UPF/PGW-U 435 may be deployed (e.g., in different geographical locations), and the delivery of content to UE 101 may be coordinated via the N9 interface (e.g., as denoted in FIG. 4 by the line marked “N9” originating and terminating at UPF/PGW-U 435). Similarly, UPF/PGW-U 435 may receive traffic from UE 101 (e.g., via RAN 410, RAN 412, SMF/PGW-C 420, and/or one or more other devices), and may forward the traffic toward DN 450. In some embodiments, UPF/PGW-U 435 may communicate (e.g., via the N4 interface) with SMF/PGW-C 420, regarding user plane data processed by UPF/PGW-U 435.

UDM/HSS 440 and AUSF 445 may include one or more devices, systems, VNFs, CNFs, etc., that manage, update, and/or store, in one or more memory devices associated with AUSF 445 and/or UDM/HSS 440, profile information associated with a subscriber. In some embodiments, UDM/HSS 440 may include, may implement, may be communicatively coupled to, and/or may otherwise be associated with some other type of repository or database, such as a UDR. AUSF 445 and/or UDM/HSS 440 may perform authentication, authorization, and/or accounting operations associated with one or more UEs 101 and/or one or more communication sessions associated with one or more UEs 101.

DN 450 may include one or more wired and/or wireless networks. For example, DN 450 may include an Internet Protocol (“IP”)-based PDN, a wide area network (“WAN”) such as the Internet, a private enterprise network, and/or one or more other networks. UE 101 may communicate, through DN 450, with data servers, other UEs 101, and/or to other servers or applications that are coupled to DN 450. DN 450 may be connected to one or more other networks, such as a public switched telephone network (“PSTN”), a public land mobile network (“PLMN”), and/or another network. DN 450 may be connected to one or more devices, such as content providers, applications, web servers, and/or other devices, with which UE 101 may communicate.

External devices 454 may include one or more devices or systems that communicate with UE 101 via DN 450 and one or more elements of 400 (e.g., via UPF/PGW-U 435). In some embodiments, external devices 454 may include, may implement, and/or may otherwise be associated with one or more application servers or other devices or systems with which UEs 101 communicate. External devices 454 may include, for example, one or more application servers, content provider systems, web servers, or the like. External devices 454 may, for example, implement “server-side” applications that communicate with “client-side” applications executed by UE 101. External devices 454 may provide services to UE 101 such as gaming services, videoconferencing services, messaging services, email services, web services, and/or other types of services. Operations described above with respect to a given external device 454 (e.g., in accordance with some embodiments) may be performed by a single device, by a cloud computing system, by one or more devices that implement a virtualized or containerized environment, a collection of devices, etc.

In some embodiments, external devices 454 may communicate with one or more elements of environment 400 (e.g., core network elements) via NEF/SCEF 449. NEF/SCEF 449 include one or more devices, systems, VNFs, CNFs, etc. that provide access to information, APIs, and/or other operations or mechanisms of one or more core network elements to devices or systems that are external to the core network (e.g., to external device 454 via DN 450). NEF/SCEF 449 may maintain authorization and/or authentication information associated with such external devices or systems, such that NEF/SCEF 449 is able to provide information, that is authorized to be provided, to the external devices or systems. For example, a given external device 454 may request particular information associated with one or more core network elements. NEF/SCEF 449 may authenticate the request and/or otherwise verify that external device 454 is authorized to receive the information, and may request, obtain, or otherwise receive the information from the one or more core network elements. In some embodiments, NEF/SCEF 449 may include, may implement, may be implemented by, may be communicatively coupled to, and/or may otherwise be associated with a Security Edge Protection Proxy (“SEPP”), which may perform some or all of the functions discussed above. External device 454 may, in some situations, subscribe to particular types of requested information provided by the one or more core network elements, and the one or more core network elements may provide (e.g., “push”) the requested information to NEF/SCEF 449 (e.g., in a periodic or otherwise ongoing basis).

In some embodiments, external devices 454 may communicate with one or more elements of RAN 410 and/or 412 via an API or other suitable interface. For example, a given external device 454 may provide instructions, requests, etc. to RAN 410 and/or 412 to provide one or more services via one or more respective MECs 414. In some embodiments, such instructions, requests, etc. may include QoS parameters, Service Level Agreements (“SLAs”), etc. (e.g., maximum latency thresholds, minimum throughput thresholds, etc.) associated with the services.

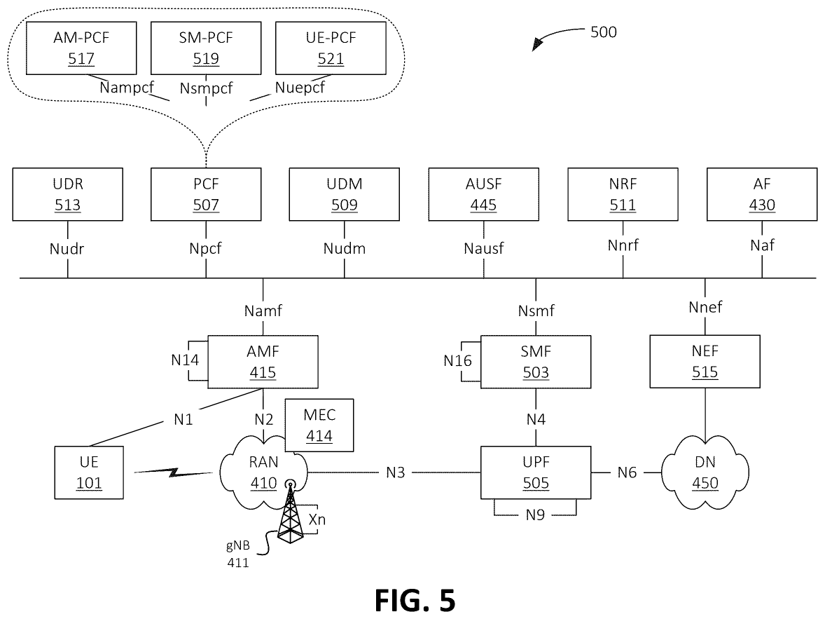

FIG. 5 illustrates another example environment 500, in which one or more embodiments may be implemented. In some embodiments, environment 500 may correspond to a 5G network, and/or may include elements of a 5G network. In some embodiments, environment 500 may correspond to a 5G SA architecture. In some embodiments, environment 500 may include a 5GC, in which 5GC network elements perform one or more operations described herein.

As shown, environment 500 may include UE 101, RAN 410 (which may include one or more gNBs 411 or other types of wireless network infrastructure) and various network functions, which may be implemented as VNFs, CNFs, etc. Such network functions may include AMF 415, SMF 503, UPF 505, PCF 507, UDM 509, AUSF 445, Network Repository Function (“NRF”) 511, AF 430, UDR 513, and NEF 515. Environment 500 may also include or may be communicatively coupled to one or more networks, such as DN 450.

The example shown in FIG. 5 illustrates one instance of each network component or function (e.g., one instance of SMF 503, UPF 505, PCF 507, UDM 509, AUSF 445, etc.). In practice, environment 500 may include multiple instances of such components or functions. For example, in some embodiments, environment 500 may include multiple “slices” of a core network, where each slice includes a discrete and/or logical set of network functions (e.g., one slice may include a first instance of SMF 503, PCF 507, UPF 505, etc., while another slice may include a second instance of SMF 503, PCF 507, UPF 505, etc.). Additionally, or alternatively, one or more of the network functions of environment 500 may implement multiple network slices. The different slices may provide differentiated levels of service, such as service in accordance with different QoS parameters.

The quantity of devices and/or networks, illustrated in FIG. 5, is provided for explanatory purposes only. In practice, environment 500 may include additional devices and/or networks, fewer devices and/or networks, different devices and/or networks, or differently arranged devices and/or networks than illustrated in FIG. 5. For example, while not shown, environment 500 may include devices that facilitate or enable communication between various components shown in environment 500, such as routers, modems, gateways, switches, hubs, etc. In some implementations, one or more devices of environment 500 may be physically integrated in, and/or may be physically attached to, one or more other devices of environment 500. Alternatively, or additionally, one or more of the devices of environment 500 may perform one or more network functions described as being performed by another one or more of the devices of environment 500.

Elements of environment 500 may interconnect with each other and/or other devices via wired connections, wireless connections, or a combination of wired and wireless connections. Examples of interfaces or communication pathways between the elements of environment 500, as shown in FIG. 5, may include interfaces shown in FIG. 5 and/or one or more interfaces not explicitly shown in FIG. 5. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 500 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 415), an Nudm interface (e.g., indicating communications to be routed to UDM 509), an Npcf interface, an Nupf interface, an Nnef interface, an Nsmf interface, an Nnrf interface, an Nudr interface, an Naf interface, and/or one or more other SBIs. In some embodiments, environment 500 may be, may include, may be implemented by, and/or may be communicatively coupled to wireless network 105.

UPF 505 may include one or more devices, systems, VNFs, CNFs, etc., that receive, route, process, and/or forward traffic (e.g., user plane traffic). As discussed above, UPF 505 may communicate with UE 101 via one or more communication sessions, such as PDU sessions. Such PDU sessions may be associated with a particular network slice or other suitable QoS parameters, as noted above. UPF 505 may receive downlink user plane traffic (e.g., voice call traffic, data traffic, etc. destined for UE 101) from DN 450, and may forward the downlink user plane traffic toward UE 101 (e.g., via RAN 410). In some embodiments, multiple UPFs 505 may be deployed (e.g., in different geographical locations), and the delivery of content to UE 101 may be coordinated via the N9 interface. Similarly, UPF 505 may receive uplink traffic from UE 101 (e.g., via RAN 410), and may forward the traffic toward DN 450. In some embodiments, UPF 505 may implement, may be implemented by, may be communicatively coupled to, and/or may otherwise be associated with UPF/PGW-U 435. In some embodiments, UPF 505 may communicate (e.g., via the N4 interface) with SMF 503, regarding user plane data processed by UPF 505 (e.g., to provide analytics or reporting information, to receive policy and/or authorization information, etc.).

PCF 507 may include one or more devices, systems, VNFs, CNFs, etc., that aggregate, derive, generate, etc. policy information associated with the 5GC and/or UEs 101 that communicate via the 5GC and/or RAN 410. PCF 507 may receive information regarding policies and/or subscriptions from one or more sources, such as subscriber databases (e.g., UDM 509, UDR 513, etc.), and/or from one or more users such as, for example, an administrator associated with PCF 507. In some embodiments, the functionality of PCF 507 may be split into multiple network functions or subsystems, such as access and mobility PCF (“AM-PCF”) 517, session management PCF (“SM-PCF”) 519, UE PCF (“UE-PCF”) 521, and so on. Such different “split” PCFs may be associated with respective SBIs (e.g., AM-PCF 517 may be associated with an Nampcf SBI, SM-PCF 519 may be associated with an Nsmpcf SBI, UE-PCF 521 may be associated with an Nuepcf SBI, and so on) via which other network functions may communicate with the split PCFs. The split PCFs may maintain information regarding policies associated with different devices, systems, and/or network functions.

NRF 511 may include one or more devices, systems, VNFs, CNFs, etc. that maintain routing and/or network topology information associated with the 5GC. For example, NRF 511 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 513 may include one or more devices, systems, VNFs, CNFs, etc. that provide user and/or subscriber information, based on which PCF 507 and/or other elements of environment 500 may determine access policies, QoS policies, charging policies, or the like. In some embodiments, UDR 513 may receive such information from UDM 509 and/or one or more other sources.

NEF 515 include one or more devices, systems, VNFs, CNFs, etc. that provide access to information, APIs, and/or other operations or mechanisms of the 5GC to devices or systems that are external to the 5GC. NEF 515 may maintain authorization and/or authentication information associated with such external devices or systems, such that NEF 515 is able to provide information, that is authorized to be provided, to the external devices or systems. Such information may be received from other network functions of the 5GC (e.g., as authorized by an administrator or other suitable entity associated with the 5GC), such as SMF 503, UPF 505, a charging function (“CHF”) of the 5GC, and/or other suitable network function. NEF 515 may communicate with external devices or systems (e.g., external devices 454) via DN 450 and/or other suitable communication pathways.

While environment 500 is described in the context of a 5GC, as noted above, environment 500 may, in some embodiments, include or implement one or more other types of core networks. For example, in some embodiments, environment 500 may be or may include a converged packet core, in which one or more elements may perform some or all of the functionality of one or more 5GC network functions and/or one or more EPC network functions. For example, in some embodiments, AMF 415 may include, may implement, may be implemented by, and/or may otherwise be associated with MME 416; SMF 503 may include, may implement, may be implemented by, and/or may otherwise be associated with SGW 417; PCF 507 may include, may implement, may be implemented by, and/or may otherwise be associated with a PCRF (e.g., PCF/PCRF 425); NEF 515 may include, may implement, may be implemented by, and/or may otherwise be associated with a SCEF (e.g., NEF/SCEF 449); and so on.

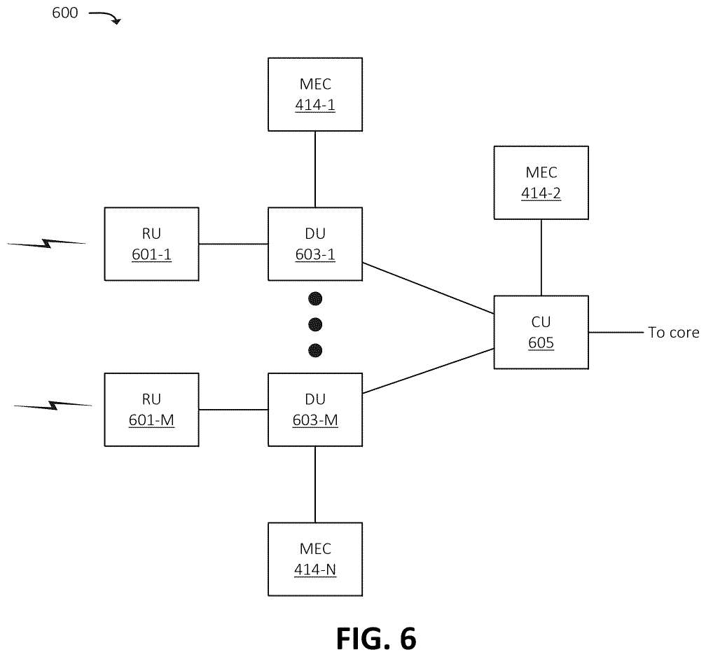

FIG. 6 illustrates an example RAN environment 600, which may be included in and/or implemented by one or more RANs (e.g., RAN 410 or some other RAN). In some embodiments, a particular RAN 410 may include one RAN environment 600. In some embodiments, a particular RAN 410 may include multiple RAN environments 600. In some embodiments, RAN environment 600 may correspond to a particular gNB 411 of RAN 410. In some embodiments, RAN environment 600 may correspond to multiple gNBs 411. In some embodiments, RAN environment 600 may correspond to one or more other types of base stations of one or more other types of RANs. As shown, RAN environment 600 may include Central Unit (“CU”) 605, one or more Distributed Units (“DUs”) 603-1 through 603-M (referred to individually as “DU 603,” or collectively as “DUs 603”), and one or more Radio Units (“RUs”) 601-1 through 601-M (referred to individually as “RU 601,” or collectively as “RUs 601”).

CU 605 may communicate with a core of a wireless network (e.g., may communicate with one or more of the devices or systems described above with respect to FIG. 5, such as AMF 415 and/or UPF 505) and/or some other device or system such as MEC 414. In the uplink direction (e.g., for traffic from UEs 101 to a core network), CU 605 may aggregate traffic from DUs 603, and forward the aggregated traffic to the core network. In some embodiments, CU 605 may receive traffic according to a given protocol (e.g., Radio Link Control (“RLC”) traffic) from DUs 603, and may perform higher-layer processing (e.g., may aggregate/process RLC packets and generate Packet Data Convergence Protocol (“PDCP”) packets based on the RLC packets) on the traffic received from DUs 603.

CU 605 may receive downlink traffic (e.g., traffic from the core network, traffic from a given MEC 414, etc.) for a particular UE 101, and may determine which DU(s) 603 should receive the downlink traffic. DU 603 may include one or more devices that transmit traffic between a core network (e.g., via CU 605) and UE 101 (e.g., via a respective RU 601). DU 603 may, for example, receive traffic from RU 601 at a first layer (e.g., physical (“PHY”) layer traffic, or lower PHY layer traffic), and may process/aggregate the traffic to a second layer (e.g., upper PHY and/or RLC). DU 603 may receive traffic from CU 605 at the second layer, may process the traffic to the first layer, and provide the processed traffic to a respective RU 601 for transmission to UE 101.

RU 601 may include hardware circuitry (e.g., one or more RF transceivers, antennas, radios, and/or other suitable hardware) to communicate wirelessly (e.g., via an RF interface) with one or more UEs 101, one or more other DUs 603 (e.g., via RUs 601 associated with DUs 603), and/or any other suitable type of device. In the uplink direction, RU 601 may receive traffic from UE 101 and/or another DU 603 via the RF interface and may provide the traffic to DU 603. In the downlink direction, RU 601 may receive traffic from DU 603, and may provide the traffic to UE 101 and/or another DU 603.

One or more elements of RAN environment 600 may, in some embodiments, be communicatively coupled to one or more MECs 414. For example, DU 603-1 may be communicatively coupled to MEC 414-1, DU 603-M may be communicatively coupled to MEC 414-N, CU 605 may be communicatively coupled to MEC 414-2, and so on. MECs 414 may include hardware resources (e.g., configurable or provisionable hardware resources) that may be configured to provide services and/or otherwise process traffic to and/or from UE 101, via a respective RU 601.

For example, DU 603-1 may route some traffic, from UE 101, to MEC 414-1 instead of to a core network via CU 605. MEC 414-1 may process the traffic, perform one or more computations based on the received traffic, and may provide traffic to UE 101 via RU 601-1. As discussed above, MEC 414 may include, and/or may implement, some or all of the functionality described above with respect to UPF 505, AF 430, and/or one or more other devices, systems, VNFs, CNFs, etc. In this manner, ultra-low latency services may be provided to UE 101, as traffic does not need to traverse DU 603, CU 605, links between DU 603 and CU 605, and an intervening backhaul network between RAN environment 600 and the core network.

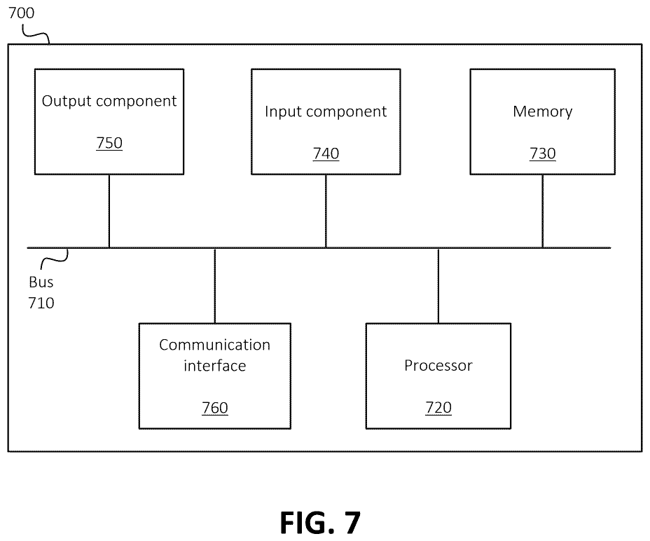

FIG. 7 illustrates example components of device 700. One or more of the devices described above may include one or more devices 700. Device 700 may include bus 710, processor 720, memory 730, input component 740, output component 750, and communication interface 760. In another implementation, device 700 may include additional, fewer, different, or differently arranged components.

Bus 710 may include one or more communication paths that permit communication among the components of device 700. Processor 720 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 720 may be or may include one or more hardware processors. Memory 730 may include any type of dynamic storage device that may store information and instructions for execution by processor 720, and/or any type of non-volatile storage device that may store information for use by processor 720.

Input component 740 may include a mechanism that permits an operator to input information to device 700 and/or other receives or detects input from a source external to input component 740, such as a touchpad, a touchscreen, a keyboard, a keypad, a button, a switch, a microphone or other audio input component, etc. In some embodiments, input component 740 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 750 may include a mechanism that outputs information to the operator, such as a display, a speaker, one or more light emitting diodes (“LEDs”), etc.

Communication interface 760 may include any transceiver-like mechanism that enables device 700 to communicate with other devices and/or systems (e.g., via RAN 410, RAN 412, DN 450, etc.). For example, communication interface 760 may include an Ethernet interface, an optical interface, a coaxial interface, or the like. Communication interface 760 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 700 may include more than one communication interface 760. For instance, device 700 may include an optical interface, a wireless interface, an Ethernet interface, and/or one or more other interfaces.

Device 700 may perform certain operations relating to one or more processes described above. Device 700 may perform these operations in response to processor 720 executing instructions, such as software instructions, processor-executable instructions, etc. stored in a computer-readable medium, such as memory 730. A computer-readable medium may be defined as a non-transitory memory device. A memory device may include space within a single physical memory device or spread across multiple physical memory devices. The instructions may be read into memory 730 from another computer-readable medium or from another device. The instructions stored in memory 730 may be processor-executable instructions that cause processor 720 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-3), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive, from an application executing at the device, a first network communication request;
establish, based on the first network communication request, a first communication session with a wireless network, wherein the first communication session is associated with a first network slice out of a plurality of network slices associated with the wireless network;
receive, from the wireless network, updated network slice information;
provide, to the application, at least a portion of the updated network slice information;
receive, from the application and after providing the updated network slice information to the application, a second network communication request; and
based on receiving the second network communication request, perform at least one of:
establish a second communication session with the wireless network, wherein the second communication session is associated with a second network slice out of the plurality of network slices associated with the wireless network, or
modify the first communication session with the wireless network, wherein the modified first communication session is associated with the second network slice.

2. The device of claim 1, wherein the first communication session includes a first protocol data unit (“PDU”) session.

3. The device of claim 2, wherein the second network communication request includes a PDU modification request, wherein modifying the first communication session is performed based on the PDU modification request.

4. The device of claim 3, wherein the first network slice information includes a first set of User Equipment (“UE”) Route Selection Policy (“URSP”) rules, and wherein the second network slice information includes a second set of URSP rules.

5. The device of claim 1, wherein the first network communication request includes an indication of the first network slice, and wherein the network communication request includes an indication of the second network slice.

6. The device of claim 1, wherein the first network communication request is established based on a first set of network slice information, wherein the updated network slice information includes a second set of network slice information.

7. The device of claim 1, wherein after establishing the first communication session, the device moves from a first location to a second location, wherein the updated network slice information is determined based on the movement of the device from the first location to the second location.

8. A non-transitory computer-readable medium, storing a plurality of processor-executable instructions to:
receive, from an application executing at a device, a first network communication request;
establish, based on the first network communication request, a first communication session with a wireless network, wherein the first communication session is associated with a first network slice out of a plurality of network slices associated with the wireless network;
receive, from the wireless network, updated network slice information;
provide, to the application, at least a portion of the updated network slice information;
receive, from the application and after providing the updated network slice information to the application, a second network communication request; and
based on receiving the second network communication request, perform at least one of:
establish a second communication session with the wireless network, wherein the second communication session is associated with a second network slice out of the plurality of network slices associated with the wireless network, or
modify the first communication session with the wireless network, wherein the modified first communication session is associated with the second network slice.

9. The non-transitory computer-readable medium of claim 8, wherein the first communication session includes a first protocol data unit (“PDU”) session.

10. The non-transitory computer-readable medium of claim 9, wherein the second network communication request includes a PDU modification request, wherein modifying the first communication session is performed based on the PDU modification request.

11. The non-transitory computer-readable medium of claim 10, wherein the first network slice information includes a first set of User Equipment (“UE”) Route Selection Policy (“URSP”) rules, and wherein the second network slice information includes a second set of URSP rules.

12. The non-transitory computer-readable medium of claim 8, wherein the first network communication request includes an indication of the first network slice, and wherein the network communication request includes an indication of the second network slice.

13. The non-transitory computer-readable medium of claim 8, wherein the first network communication request is established based on a first set of network slice information, wherein the updated network slice information includes a second set of network slice information.

14. The non-transitory computer-readable medium of claim 8, wherein after establishing the first communication session, the device moves from a first location to a second location, wherein the updated network slice information is determined based on the movement of the device from the first location to the second location.

15. A method, comprising:
receiving, from an application executing at a device, a first network communication request;
establishing, based on the first network communication request, a first communication session with a wireless network, wherein the first communication session is associated with a first network slice out of a plurality of network slices associated with the wireless network;
receiving, from the wireless network, updated network slice information;
providing, to the application, at least a portion of the updated network slice information;
receiving, from the application and after providing the updated network slice information to the application, a second network communication request; and
based on receiving the second network communication request, performing at least one of:
establishing, based on the second network communication request, a second communication session with the wireless network, wherein the second communication session is associated with a second network slice out of the plurality of network slices associated with the wireless network, or
modifying the first communication session with the wireless network, wherein the modified first communication session is associated with the second network slice.

16. The method of claim 15, wherein the first communication session includes a first protocol data unit (“PDU”) session, wherein the second network communication request includes a PDU modification request, and wherein modifying the first communication session is performed based on the PDU modification request.

17. The method of claim 16, wherein the first network slice information includes a first set of User Equipment (“UE”) Route Selection Policy (“URSP”) rules, and wherein the second network slice information includes a second set of URSP rules.

18. The method of claim 15, wherein the first network communication request includes an indication of the first network slice, and wherein the network communication request includes an indication of the second network slice.

19. The method of claim 15, wherein the first network communication request is established based on a first set of network slice information, wherein the updated network slice information includes a second set of network slice information.

20. The method of claim 15, wherein after establishing the first communication session, the device moves from a first location to a second location, wherein the updated network slice information is determined based on the movement of the device from the first location to the second location.
